(19) United States
(12) Patent Application Publication
(10) Pub. No.: US 2025/0231758 A1
(43) Pub. Date: Jul. 17, 2025

(54) SYSTEM AND METHOD FOR GENERATING ALTERNATIVE SOFTWARE CONFIGURATIONS USING ADVANCED COMPUTATIONAL MODELS FOR DATA ANALYSIS AND AUTOMATED PROCESSING

(71) Applicant: BANK OF AMERICA CORPORATION, Charlotte, NC (US)

(72) Inventors: Naveen Reddy Mamidi, Hyderabad (IN); Varun Vidyadharan Ezhava, Hyderabad (IN); Maneesh Kumar Sethia, Hyderabad (IN)

(73) Assignee: BANK OF AMERICA CORPORATION, Charlotte, NC (US)

(21) Appl. No.: 18/414,268

(22) Filed: Jan. 16, 2024

(51) Int. Cl. G06F 8/65

(52) U.S. Cl. CPC G06F 8/65

(57) ABSTRACT

Systems, computer program products, and methods are described herein for generating alternative software configurations using advanced computational models for data analysis and automated processing. The present disclosure is configured to analyze a software configuration to determine a non-compliant software portion, wherein the non-compliant software portion comprises a mismatch between at least a portion of the software configuration and a compliance database. Further, the present disclosure is configured to receive a compliant software portion, wherein the compliant software portion is associated with the compliance database. Further, the present disclosure is configured to reconfigure, using an artificial intelligence model, the software configuration to include the compliant software portion, wherein reconfiguring the software configuration comprises modifying the software configuration to comply with the compliance database. Further, the present disclosure is configured to deploy an updated software configuration, wherein the updated software configuration comprises the compliant software portion.

### TECHNOLOGICAL FIELD

Example embodiments of the present disclosure relate to generating alternative software configurations using advanced computational models for data analysis and automated processing.

### BACKGROUND

There are significant challenges associated with generating software configurations directed towards those with disabilities. Applicant has identified a number of deficiencies and problems associated with generating alternative software configurations using advanced computational models for data analysis and automated processing. Through applied effort, ingenuity, and innovation, many of these identified problems have been solved by developing solutions that are included in embodiments of the present disclosure, many examples of which are described in detail herein

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for generating alternative software configurations using advanced computational models for data analysis and automated processing.

Embodiments of the present invention address the above needs and/or achieve other advantages by providing apparatuses (e.g., a system, computer program product, and/or other devices) and methods for generating alternative software configurations using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present disclosure analyzes a software configuration to determine a non-compliant software portion, wherein the non-compliant software portion comprises a mismatch between at least a portion of the software configuration and a compliance database. In some embodiments, the present disclosure receives a compliant software portion, wherein the compliant software portion is associated with the compliance database. In some embodiments, the present disclosure reconfigures, using an artificial intelligence model, the software configuration to include the compliant software portion, wherein reconfiguring the software configuration comprises modifying the software configuration to comply with the compliance database. In some embodiments, the present disclosure deploys an updated software configuration, wherein the updated software configuration comprises the compliant software portion.

In some embodiments, the compliance database is associated with a disability network, wherein the disability network creates the compliance database to provide guidelines for configuring the software configuration.

In some embodiments, analyzing the software configuration to determine the non-compliant software portion further comprises comparing, using the artificial intelligence model, the software configuration with the compliance database. In some embodiments, analyzing the software configuration to determine the non-compliant software portion further comprises identifying, within the software configuration, the non-compliant software portion, wherein the non-compliant software portion comprises a determination that the non-compliant software portion does not match at least a portion of the compliant database.

In some embodiments, receiving the compliant software portion comprises using smart contracts to transmit data from the compliance database.

In some embodiments, the compliance database comprises a non-SQL database.

In some embodiments, the artificial intelligence model comprises at least a cognitive artificial intelligence model and a cognitive computing model.

In some embodiments, the present disclosure further includes analyzing the updated software configuration to determine a match between the updated software configuration and the compliance database. In some embodiments, the present disclosure further includes deploying the updated software configuration.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating alternative software configurations using advanced computational models for data analysis and automated processing, in accordance with an embodiment of the disclosure;

FIG. 2 illustrates a process flow for generating alternative software configurations using advanced computational models for data analysis and automated processing, in accordance with an embodiment of the disclosure; and

FIG. 3 illustrates a non-limiting example process flow of the alternative software configuration system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the modern world, software configurations, applications, programs, systems, and the like allow for interconnectivity on a global scale. The ease at which a user may connect with another entity is made possible by technological advancements that include, but are not limited to, design, layout, interfacing, and the like of the software through which the user interacts. In other words, while data communications on such a large scale may be complex, the user interacting with the software is typically presented in a simple and easy to use interface. This, however, is usually made under the assumption that the user is not disabled nor impaired in a way that effects the user's ability to sense and/or interact with the world. Further, the design of such software configurations, applications, or the like, are similarly designed under that same assumption. Those with disabilities, therefore, do not have a comparable software interface experience as compared to users who are not disabled.

The present invention may scan software code of an application that is not in compliance with the Americans with Disabilities Act (ADA). The non-ADA software code may have elements or sections of code that are not in compliance with the ADA. In this way, the software code may not have features for a screen reader, forward tabbing, reverse tabbing, screen contrasting, and/or the like. The invention may then, using Smart Contract Rules, identify the rule(s) which make the element ADA compliant with regard to the element's type and/or functionality. Next, the invention may map the rule with the element's source code in a database (such as a non-SQL database). The updated application (with the compliant elements) may then be built and deployed using an artificial intelligence model. The artificial intelligence model may use cognitive artificial intelligence, cognitive computing, machine learning, and/or the like to build the updated application. The invention may cross check the non-SQL database to determine whether another update is needed to bring the application into compliance. For example, if the application is missing a screen reader, the artificial intelligence model may build a screen reader for the application. The changes to the application may be made during runtime which allows the invention to achieve Green Build (e.g., a reduction in resource and carbon emissions for the build process of the updated application).

What is more, the present disclosure provides a technical solution to a technical problem. As described herein, the technical problem includes software configurations that do not comply with a disability pane's compliance database. In this way, users of the software configuration may not be able to use the software configuration to its full functionality, especially if the users have a disability, or the like. The technical solution presented herein allows for configuring (e.g., reconfiguring) a software configuration to modify the software configuration to comply with a compliance database, wherein the compliance database is associated with a disability panel. In particular, the alternative software configuration system is an improvement over existing solutions to the issue of software configuration non-compliance with a compliance database, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer itself. Specifically, the alternative software configuration system as described herein is a solution to the problem of a software configuration's non-compliance with a compliance database. Further, the alternative software configuration system may be characterized as identifying a specific improvement in computer capabilities and/or network functionalities in response to the reconfiguration of at least a portion of the software configuration using an artificial intelligence model. In this way, the alternative software configuration system improves the capability of a system by efficiently and effectively integrating compliance database guidelines, portions, sections, suggestions, and/or the like into a software configuration. Further, the alternative software configuration system improves the functionality of networks in response to reducing the resources consumed by the system (e.g., network resources, computing resources, memory resources, and/or the like).

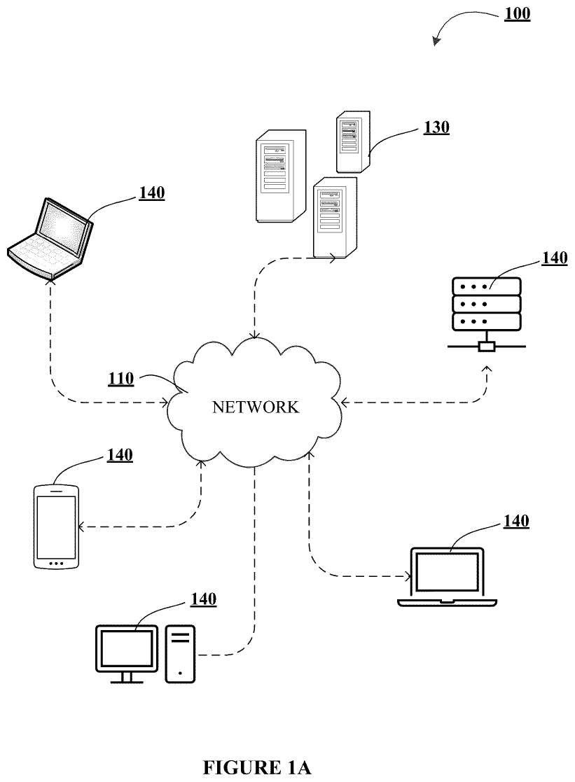

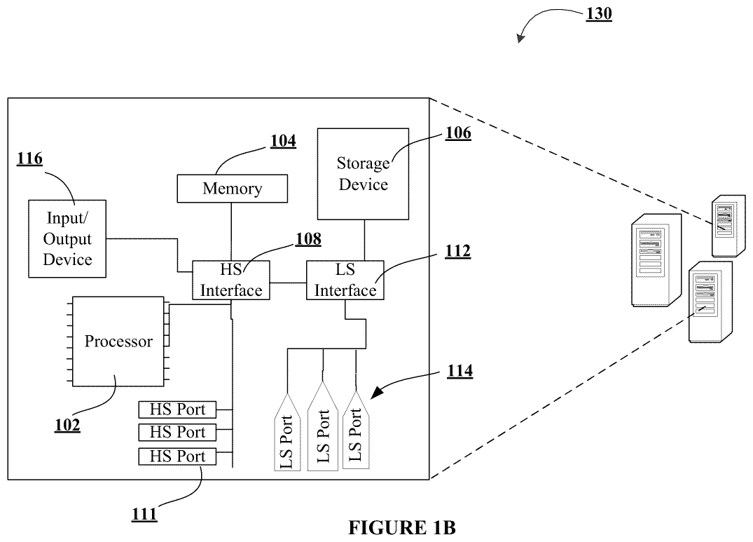

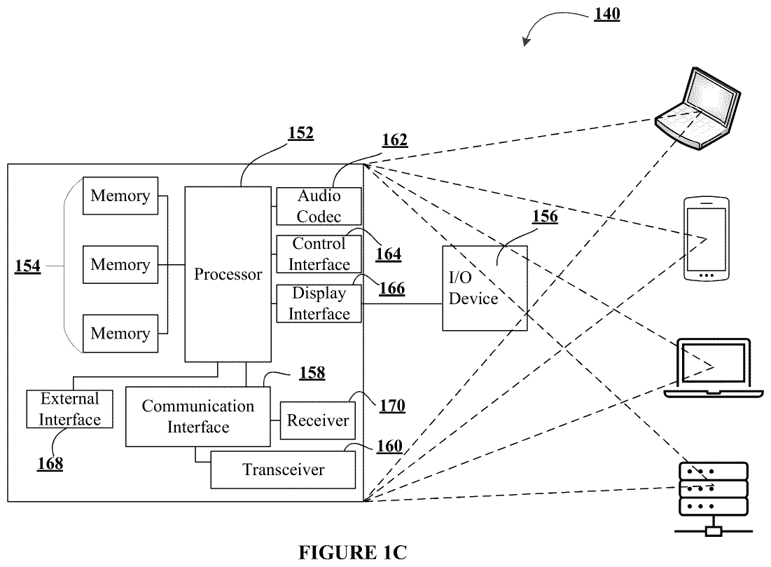

FIGS. 1A-1C illustrate technical components of an exemplary distributed computing environment 100 for generating alternative software configurations using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC,
WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

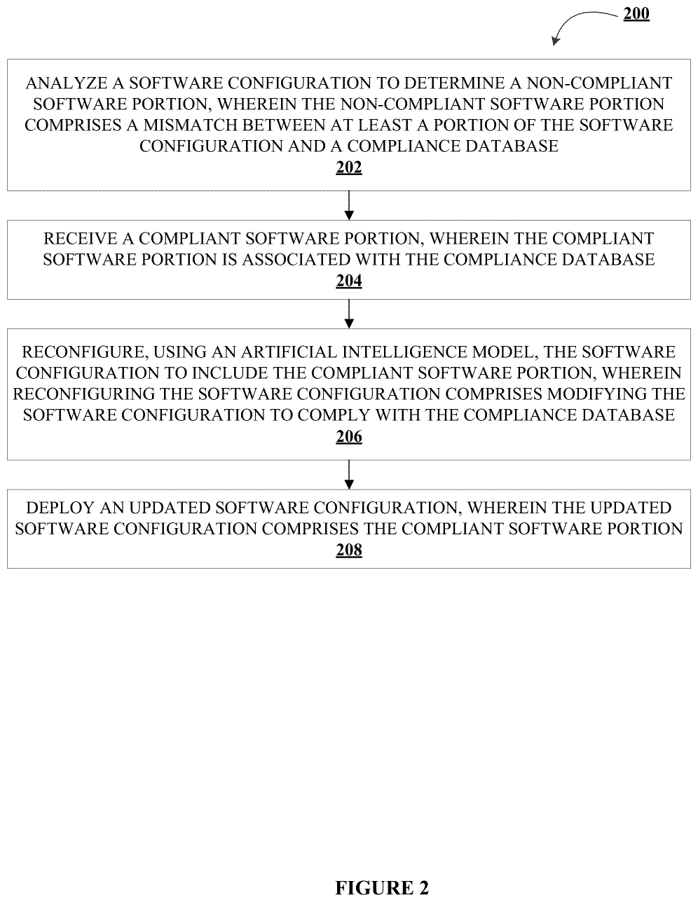

FIG. 2 illustrations a process flow for generating alternative software configurations using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an alternative software configuration system (e.g., similar to one or more of the systems described herein with respect to FIGS. 1A-1C) may perform one or more of the steps of process flow 200. For example, the alternative software configuration system (e.g., the system 130 described herein with respect to FIGS. 1A-1C) may perform the steps of process flow 200.

As shown in block 202, the process flow of this embodiment includes analyzing a software configuration to determine a non-compliant software portion, wherein the non-compliant software portion includes a mismatch between at least a portion of the software configuration and a compliance database.

As used herein, a “software configuration” may include a source code, an application, a software, a program, computer code, machine code, user interface design, virtual reality interface, augmented reality interface, extended reality interface, parallel reality interface, and/or the like and/or the like. Further, “software configuration” may include the full code associated with the software (e.g., the entire source code), or any sized portion (e.g., a portion of an application's code). As used herein, a non-compliant software portion may include any portion of a software configuration that is determined to be non-compliant. In this way, the remaining portion of the software configuration may be compliant, non-compliant, or a combination of the foregoing. The non-compliant software portion may be a portion of the software configuration that is determined to be non-compliant. As used herein, a “mismatch” may include a determination that the portion of the software configuration (e.g., the non-compliant software portion) does not match a compliance database. The compliance database may include guidelines, suggestions, rules, laws, regulations, and/or the like for software configurations as they relate to users with disabilities. The compliance database may include a series of accessibility guidelines, wherein the accessibility guidelines are a set of recommendations for making software configurations more accessible, primarily for people with disabilities. The compliance database may be based on the Web Content Accessibility Guidelines (WCAG), the Web Accessibility Initiative (WAI), the Americans with Disabilities Act (ADA), and/or the like. The compliance database may include standards for features such as a screen reader, forward tabbing, reverse tabbing, screen contrasting, captioning, audio descriptions, sign language, text resizing, orientations of objects, use of colors, images of text, and/or the like.

The WCAG may include subdivisions of conformance levels that may require differing types of software configurations. For example, the WCAG may include Level A, Level AA, and Level AAA conformance levels. Level A may set a minimum level of accessibility requirements the software configuration must meet in order to be considered compliant. Level AA may include guidelines and recommendations for web-based information of the software configuration. Level AAA may include stringent requirements set to ensure accessibility options for those users with disabilities. Further, the WCAG may have versions that may be better suited for those with disabilities. In this way, the WCAG versions may include guidelines and/or recommendations for the software configuration based on the following categories: perceivable, operable, understandable, and robust.

As an example, a WCAG Level A guideline may include a pointer cancellation feature, allowing users to cancel an action they may have triggered accidentally. The guideline may include recommendations on a no down-event (e.g., the action is not activated on a down-click of a mouse), an undo (e.g., the action may be reversed), an up reversal (e.g., the action may be reversed on a held-click of a mouse), or an essential feature (e.g., the function is activated on the down-lick of a mouse for an important reason). As another example, a WCAG Level AA guideline may require the software configuration may be able to be oriented in both the portrait and landscape orientation on a mobile device. This guideline may ensure those with vision impairments can change the orientation of the software configuration to make it easier to see. As a further example, a WCAG Level AAA guideline may provide the software configuration should contain a timeout to alert users with cognitive disabilities that inactivity could result in a page timeout and/or data loss. In this way, the software configuration may include a timeout alert for such users to ensure they are presented with notifications to save their work or take action to prevent data loss.

In some embodiments, the compliance database may be associated with a disability network, wherein the disability network creates the compliance database to provide guidelines for configuring the software configuration. The disability network may be comprised of a group of individuals, a computing system, one or more entities, and/or the like. The disability network may produce a document, form, set of guidelines, set of rules, set of regulations, set of recommendations, and/or the like that aid in configuring a software configuration for users with disabilities. In this way, the disability network may control (e.g., through creation, editing, upkeep, and/or the like) the compliance database.

The determination of the mismatch between the non-compliant software portion and the compliance database may include comparing the software configuration with the compliance database to determine which portions of the software configuration are non-compliant. In some embodiments, determining the mismatch may be a targeted approach, which may include a specific search through the software configuration to determine whether it matches the compliance database's recommendations on a specific feature. For example, a targeted search of the software configuration may include searching the software configuration for an orientation feature.

In some embodiments, analyzing the software configuration to determine the non-compliant software portion includes comparing, using the artificial intelligence model, the software configuration with the compliance database. In some embodiments, analyzing the software configuration to determine the non-compliant software portion includes identifying, within the software configuration, the non-compliant software portion, wherein the non-compliant software portion includes a determine that the non-compliant software portion does not match at least a portion of the compliance database.

In some embodiments, the artificial intelligence model may include natural language processing (NLP), supervised learning, unsupervised learning, deep learning, sentiment analysis, semantic analysis, neural networks, and/or the like. In this way, the artificial intelligence model may determine whether the software configuration matches the compliance database. For example, the artificial intelligence model may determine the compliance database requires a specific feature (e.g., a screen reader) to be included for software to be considered compliant. If the artificial intelligence model determines the software configuration does not contain a screen reader, the artificial intelligence model may determine the software configuration contains a non-compliant software portion. In this way, the non-compliant software portion may relate to a missing feature required by the compliance database.

In another example, the compliance database may require a specific screen contrast for an interactive button. If it is determined, through the artificial intelligence model, the software configuration has an interactive button, but not the specific screen contrast, the artificial intelligence may determine a non-compliant software portion exists. In this way, the non-compliant software portion may relate to an out of compliance feature.

In some embodiments, the compliance database comprises a non-Standard Query Language (non-SQL or NoSQL) database. In some embodiments, the compliance database may be any kind of database, which may include object databases, relational databases, graph databases, network databases, cloud databases, document databases, operational databases, distributed databases, multimodal databases, hierarchical databases, standard query language (SQL) databases, and/or the like.

If the compliance database is a non-SQL type database, the system may benefit from the scaling efficiency of the non-SQL database. In this way, expanding the database may become resource efficient as compared to other types of databases, leading to a reduction of resources in building, expansion, and/or maintenance of the database. Further, updates to the database may benefit from a similar resource efficiency due to the structure of the non-SQL database.

As shown in block 204, the process flow of this embodiment includes receiving a compliant software portion, wherein the compliant software portion is associated with the compliance database. As used herein, the “compliant software portion” may include a feature, element, application, code, and/or the like, that may be used in the software configuration. For example, the compliant software portion may include a feature, such as a screen reader, that may be implemented into the software configuration. In this example, the compliance database may require the screen reader in the software configuration and the system (e.g., system 130) may implement the screen reader to bring the software configuration into compliance. The compliant software portion may comprise a new feature or may comprise editing and/or updating the software configuration based on the compliance database.

In some embodiments, receiving the compliant software portion includes using smart contracts to transmit data from the compliance database. In some embodiments, the smart contracts may execute automatically upon the determination that the software configuration includes a non-compliant software portion.

As shown in block 206, the process flow of this embodiment includes reconfiguring, using an artificial intelligence model, the software configuration to include the compliant software portion, wherein reconfiguring the software configuration comprises modifying the software configuration to comply with the compliance database. In some embodiments the artificial intelligence (AI) model includes at least a cognitive artificial intelligence model and a cognitive computing model. The cognitive AI may include understanding, reasoning, learning, interacting, and/or the like for determining how the software configuration should be reconfigured. Further, the cognitive AI model may learn and adapt from previous iterations of configurations and/or reconfigurations while using complex problem solving, natural language processing (NLP), and other applications. The cognitive computing model may integrate multiple AI technologies such as machine learning, NLP, data mining, and/or the like to analyze the compliance database and provide reconfigurations to comply with the compliance database.

In some embodiments, the cognitive AI and cognitive computing models may work together to scan the code and determine an appropriate reconfiguration of the software configuration. In this way, the cognitive computing model may ingest the data associated with the software configuration and the compliance database. Next, the cognitive AI may provide a contextual understanding of the data by processing the data through using NLP (and/or other technologies) to interpret the data. The cognitive AI model may then generate recommendations (e.g., the compliant software portion) and the cognitive computing model may analyze the recommendations to ensure they are suitable to comply with the compliance database.

As shown in block 208, the process flow of this embodiment includes deploying an updated software configuration, wherein the updated software configuration comprises the compliant software portion. In some embodiments, the invention may analyze the updated software configuration to determine a match between the updated software configuration and the compliance database. Analyzing the updated software configuration may include comparing the updated software configuration with the compliance database. The AI model may perform the comparison between the updated software configuration and the compliance database. In this way, the AI may use the associated tools (NLP, sentiment analysis, semantic analysis, etc.) to determine the meaning of the rules of the compliance database.

Determining the match between the updated software configuration and the compliance database may include using the AI model to determine that the updated software configuration contains the appropriate rule, as required by the compliance database. In this way, if the AI model finds the rule in the compliance database in the updated software configuration, a match may be determined to exist.

In some embodiments the invention may deploy the updated software configuration. Once a match is determined, the updated software configuration may be deployed. Deploying the updated software configuration may include making the updated software configuration available for users to use and interact with. In some embodiments, this may include building a new and separate updated software configuration from the original software configuration. In some embodiments, deploying the updated software configuration may include editing the existing software configuration.

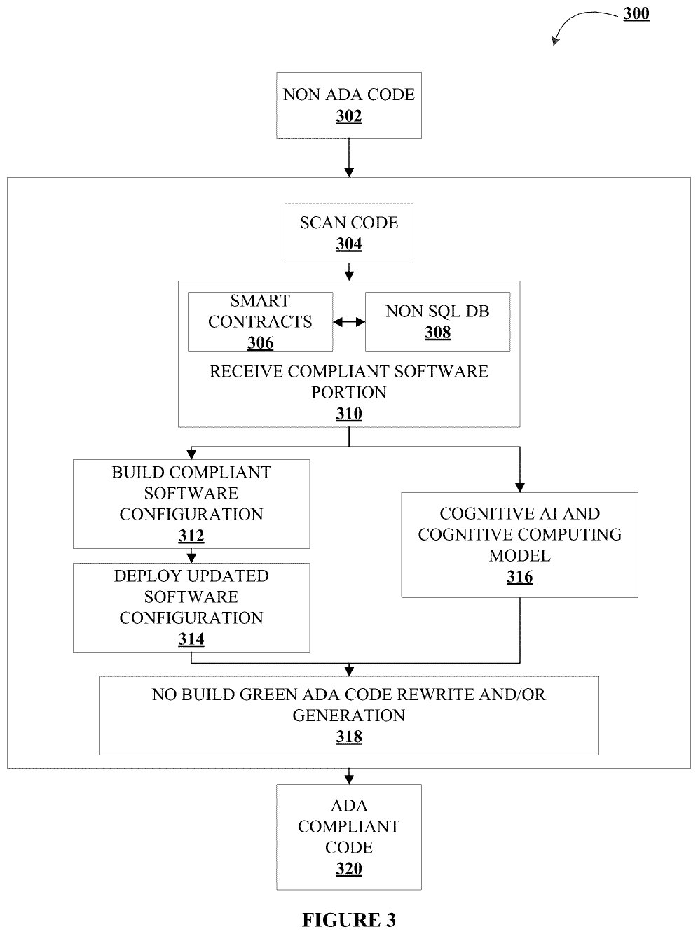

FIG. 3 illustrations a non-limiting example process flow of the alternative software configuration, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an alternative software configuration system (e.g., similar to one or more of the systems described herein with respect to FIGS. 1A-1C) may perform one or more of the steps of process flow 300. For example, the alternative software configuration system (e.g., the system 130 described herein with respect to FIGS. 1A-1C) may perform the steps of process flow 300.

As shown in block 302, the process flow of this embodiment includes non-ADA code. The non-ADA may include code that does not comply with the Americans with Disabilities Act. In this way, the code may include a software configuration, an application, user interface design, virtual reality interface, augmented reality interface, extended reality interface, parallel reality interface, and/or the like. For the code to be categorized as non-compliant, the ADA may have certain requirements that the code does not follow. For instance, the code may be missing certain features or may not have the correct configuration as described by the compliance data base (e.g., ADA).

In some embodiments, the compliance database may include interpretations of the ADA. For instance, the WCAG may provide interpretations of the ADA that may be used as the compliance database. In some embodiments, the WCAG interpretations of the ADA may be used to check against the code (e.g., software configuration) to determine if the code complies with the ADA.

As shown in block 304, the process flow of this embodiment includes scanning code. The system (e.g., system 130) may then scan the code (e.g., software configuration) to determine which portion(s) of the code should be updated, reconfigured, added, edited, and/or the like. The code may be scanned with an artificial intelligence (AI) model. The AI model may scan the code to determine which portions are non-compliant with the compliance database.

As shown in block 306, the process flow of this embodiment includes smart contracts. The smart contracts may be used to transfer the compliant software portions from the compliance database. In this way, the AI model may, after detecting a non-compliant portion of code, receive a smart contract, wherein the smart contract may indicate how to reconfigure the software configuration for it to comply with the compliance database. The smart contract may include information relating to the compliance database and specifications on how to reconfigure the code. For instance, if code is determined to be out of compliance due to a missing orientation feature, the smart contract may include the compliance database's guidelines on the orientation feature as well as specifications on how to reconfigure the code to incorporate the orientation feature.

As shown in block 308, the process flow of this embodiment includes non-SQL database (DB). The non-SQL database may include a repository of code provisions used to update the code for the code to comply with the compliance database. In this way, the non-SQL DB may interact with the smart contract to pull the correct code configuration as it relates to the guidelines of the compliance database. For instance, if the orientation feature (as required by the compliance database) is missing in the code, the smart contract may interact with the non-SQL DB to determine which code provisions should apply to the code. In this way, the non-SQL DB may store code configurations that may bring the code into compliance with the compliance database.

As shown in block 310, the process flow of this embodiment includes receiving compliant software portion. The interaction between the smart contract and the non-SQL DB may include transmitting the compliant software portion to the system (e.g., system 130) for integration with the code. In this way, having the smart contract determine which portion of the compliance database applies to the non-compliant code portion, and then having the non-SQL DB transmit the compliant code portion may result in indicating which compliant software portion should be integrated into the code.

As shown in block 312, the process flow of this embodiment includes building compliant software configuration. The system may build the compliant software configuration that may include the compliant software portion resulting from the smart contract and non-SQL DB interaction. In some embodiments, building the compliant software configuration may include building a new software configuration that may act in place of the original software configuration. In some embodiments, building the compliant software configuration may include updating the original software configuration with the compliant software portion.

As shown in block 314, the process flow of this embodiment includes building deploying updated software configuration. Deploying the updated software configuration may include final testing and quality checks, preparing the environment the software configuration is associated with, code and data migration of the software configuration, testing, monitoring, and/or the like. In this way, the deployment may include testing to ensure the updated software configuration is working properly. In some embodiments, deploying the updated software configuration may include a dynamic code configuration. In this way, the code may be dynamically configured to comply with the compliance database.

As shown in block 316, the process flow of this embodiment includes cognitive artificial intelligence (AI) and cognitive computing model. The AI and cognitive computing models may be incorporated to assist with updating the software configuration. In this way, the AI and cognitive computing models may determine which code portions require updating to be in compliance with the compliance database, searching the compliance database, handling the smart contracts, retrieving relevant portions from the non-SQL DB, and/or the like. Further, the AI and cognitive computing models may build the compliant software configuration and deploy the updated software configuration. In this way, the AI and cognitive computing models may update the code (e.g., software configuration) by writing, rewriting, and/or editing the code for it to comply with the compliance database.

As shown in block 318, the process flow of this embodiment includes a no build green ADA code rewrite and/or generation. In some embodiments, the code may be re-checked against the compliance database to ensure it complies with the relevant provisions of the compliance database. Further, the AI and cognitive computing models handling the smart contracts, non-SQL DB searching, building of the software configuration, and deploying the updated software configuration may conserve resources (e.g., computing resources, networking resources, memory resources, and/or the like). In this way, updating the code (e.g., software configuration) may be considered a green initiative due to the conservation of such resources. In addition, the conservation of resources may extend to the user-side of the software configuration because of the time saved, issues minimized, additional accessibility, and/or the like of the compliant software configuration.

In addition, a cognitive AI engine, a runtime processing engine, a deployment engine, and a unit testing engine may be included in the no build green ADA code rewrite and/or generation step. The cognitive AI may use a runtime processing engine to determine the code of the updated software configuration executes properly, manage the resources during code execution, handle errors, isolate the environment, and/or the like. Further, the deployment engine may be used to deploy the updated software configuration. The unit testing may be used to determine how the updated software configuration reacts to real-world data.

As shown in block 320, the process flow of this embodiment includes ADA compliant code. The ADA compliant code may include the software configuration that incorporates the updated software configuration. In this way, the ADA compliant code may meet the requirements of the compliance database.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating alternative software configurations using advanced computational models for data analysis and automated processing, the system comprising:
a processing device;
a non-transitory storage device containing instructions when executed by the processing device, causes the processing device to perform the steps of:
analyze a software configuration to determine a non-compliant software portion, wherein the non-compliant software portion comprises a mismatch between at least a portion of the software configuration and a compliance database;
receive a compliant software portion, wherein the compliant software portion is associated with the compliance database;
reconfigure, using an artificial intelligence model, the software configuration to include the compliant software portion, wherein reconfiguring the software configuration comprises modifying the software configuration to comply with the compliance database; and
deploy an updated software configuration, wherein the updated software configuration comprises the compliant software portion.

2. The system of claim 1, wherein the compliance database is associated with a disability network, and wherein the disability network creates the compliance database to provide guidelines for configuring the software configuration.

3. The system of claim 1, wherein analyzing the software configuration to determine the non-compliant software portion further comprises:
comparing, using the artificial intelligence model, the software configuration with the compliance database; and
identifying, within the software configuration, the non-compliant software portion, wherein the non-compliant software portion comprises a determination that the non-compliant software portion does not match at least a portion of the compliance database.

4. The system of claim 1, wherein receiving the compliant software portion comprises using smart contracts to transmit data from the compliance database.

5. The system of claim 1, wherein the compliance database comprises a non-SQL database.

6. The system of claim 1, wherein the artificial intelligence model comprises at least a cognitive artificial intelligence model and a cognitive computing model.

7. The system of claim 1, wherein executing the instructions further causes the processing device to:
analyze the updated software configuration to determine a match between the updated software configuration and the compliance database; and
deploy the updated software configuration.

8. A computer program product for generating alternative software configurations using advanced computational models for data analysis and automated processing, the computer program product comprising a non-transitory computer-readable medium comprising code causing an apparatus to:
analyze a software configuration to determine a non-compliant software portion, wherein the non-compliant software portion comprises a mismatch between at least a portion of the software configuration and a compliance database;
receive a compliant software portion, wherein the compliant software portion is associated with the compliance database;
reconfigure, using an artificial intelligence model, the software configuration to include the compliant software portion, wherein reconfiguring the software configuration comprises modifying the software configuration to comply with the compliance database; and
deploy an updated software configuration, wherein the updated software configuration comprises the compliant software portion.

9. The computer program product of claim 8, wherein the compliance database is associated with a disability network, and wherein the disability network creates the compliance database to provide guidelines for configuring the software configuration.

10. The computer program product of claim 8, wherein analyzing the software configuration to determine the non-compliant software portion further comprises:
comparing, using the artificial intelligence model, the software configuration with the compliance database; and
identifying, within the software configuration, the non-compliant software portion, wherein the non-compliant software portion comprises a determination that the non-compliant software portion does not match at least a portion of the compliance database.

11. The computer program product of claim 8, wherein receiving the compliant software portion comprises using smart contracts to transmit data from the compliance database.

12. The computer program product of claim 8, wherein the compliance database comprises a non-SQL database.

13. The computer program product of claim 8, wherein the artificial intelligence model comprises at least a cognitive artificial intelligence model and a cognitive computer model.

14. The computer program product of claim 8, wherein executing the instructions further causes the processing device to:
analyze the updated software configuration to determine a match between the updated software configuration and the compliance database; and
deploy the updated software configuration.

15. A method for generating alternative software configurations using advanced computational models for data analysis and automated processing, the method comprising:
analyzing a software configuration to determine a non-compliant software portion, wherein the non-compliant software portion comprises a mismatch between at least a portion of the software configuration and a compliance database;
receiving a compliant software portion, wherein the compliant software portion is associated with the compliance database;
reconfiguring, using an artificial intelligence model, the software configuration to include the compliant software portion, wherein reconfiguring the software configuration comprises modifying the software configuration to comply with the compliance database; and
deploying an updated software configuration, wherein the updated software configuration comprises the compliant software portion.

16. The method of claim 15, wherein the compliance database is associated with a disability network, and wherein the disability network creates the compliance database to provide guidelines for configuring the software configuration.

17. The method of claim 15, wherein analyzing the software configuration to determine the non-compliant software portion further comprises:
comparing, using the artificial intelligence model, the software configuration with the compliance database; and
identifying, within the software configuration, the non-compliant software portion, wherein the non-compliant software portion comprises a determination that the non-compliant software portion does not match at least a portion of the compliance database.

18. The method of claim 15, wherein receiving the compliant software portion comprises using smart contracts to transmit data from the compliance database.

19. The method of claim 15, wherein the compliance database comprises a non-SQL database.

20. The method of claim 15, wherein the artificial intelligence model comprises at least a cognitive artificial intelligence model and a cognitive computing model.
